(19) United States
(12) Patent Application Publication
(10) Pub. No.: US 2006/0230028 A1
(43) Pub. Date: Oct. 12, 2006

(54) Apparatus and method for constructing complex database query statements based on business analysis comparators

(75) Inventors: Nicholas Guy Kellet, Kelowna (CA); Richard David Webster, Vancouver (CA)

Correspondence Address: COOLEY GODWARD, LLP, 3000 EL CAMINO REAL, 5 PALO ALTO SQUARE, PALO ALTO, CA, 94306, US

(73) Assignee: Business Objects, S.A., Levallois-Perret (FR)

(21) Appl. No.: 11/102,562

(22) Filed: Apr. 7, 2005

(51) Int. Cl. G06F 17/30

(52) U.S. Cl. 707/3

(57) ABSTRACT

A computer readable medium includes executable instructions to construct a database query based on a comparator. Executable instructions accept a comparator forming a part of a text question. A value that defines a subject within a text question is received. A structured database query is built based upon the comparator and the subject of the text question.

### CROSS-REFERENCES TO RELATED APPLICATIONS

This application is related to the following concurrently filed, commonly owned patent applications, each of which is incorporated by reference herein:

Apparatus and Method for Deterministically Constructing a Text Question for Application to a Data Source, Ser. No. ______, filed Apr. 7, 2005;

Apparatus and Method for Utilizing Sentence Component Metadata to Create Database Queries, Ser. No. ______, filed Apr. 7, 2005; and

Apparatus and Method for Data Modeling Business Logic, Ser. No. ______, filed Apr. 7, 2005.

### BRIEF DESCRIPTION OF THE INVENTION

This invention relates generally to accessing digital data. More particularly, this invention relates to a technique to enable a novice end user to express a complex query relationship using an easily understood question style or comparator.

### BACKGROUND OF THE INVENTION

Business Intelligence generally refers to software tools used to improve business enterprise decision-making. These tools are commonly applied to financial, human resource, marketing, sales, customer, and supplier analyses. More specifically, these tools can include: reporting and analysis tools to present information; content delivery infrastructure systems for delivery and management of reports and analytics; data warehousing systems for cleansing and consolidating information from disparate sources; and, data management systems, such as relational databases or On Line Analytic Processing (OLAP) systems used to collect, store, and manage raw data.

Given the disparate roles performed by Business Intelligence tools and the vast amount of data that they are applied against, there are ongoing efforts to simplify their use. In their most successful manifestations, non-technically trained personnel can use Business Intelligence tools. To achieve this, it is important to insulate non-technically trained personnel from the complexities of the underlying data sources. Users of Business Intelligence tools generally have knowledge of the information that they want; the challenge is translating this knowledge into appropriate queries that can be applied to an underlying data source.

Ideally, a Business Intelligence tool provides an interface that allows a user to think on his or her own terms, but still allows for data source queries that can be efficiently applied against a data source. Since Business Intelligence users commonly think in terms of different question styles that select a specific set of subjects from a larger group of subjects (based on such things as date objects, date ranges, measures, behaviors, subject attributes, and specific values for calculations within the comparator), it would be desirable to provide such users with preformed comparators that could be used to construct queries. It would also be desirable to provide users with user-selected modifications and specifications to form the specific questions that the user wants to construct. For example, a user should be able to easily ask such questions as “Who are the customers that are above average buyers, by at least 20%, based on sales in the last year” or “What accounts are decreased or lapsed based on items purchased for the last full quarter versus the previous full quarter?” These sorts of questions provide the kind of information that is needed to interpret Business Intelligence data and make effective decisions based on the data. Unfortunately, these sorts of questions are often extremely challenging for users to form in current Business Intelligence products. Ideally, such a system would enable the user to form these questions without requiring knowledge about SQL, software programming, or the details of the underlying data source.

### SUMMARY OF THE INVENTION

The invention includes a computer readable medium with executable instructions to construct a database query based on a comparator. Executable instructions accept a comparator forming a part of a text question. A value that defines a subject within a text question is received. A structured database query is built based upon the comparator and the subject of the text question.

The invention provides a category of question styles, or comparators, that provide the logic that enables a user to construct a question that selects a specific set of subjects from a larger group of subjects (based on such things as date objects, date ranges, measures, behaviors, subject attributes, and specific values for calculations within the comparator). This question can be used directly and/or with user-selected modifications and specifications to form the specific questions that the user wants to ask about the data. The invention includes the process for generating specific database queries based on the question.

Comparators provide easily understood business analysis specifications. Often what appear to be a fairly simple but very useful business questions such as, “which sales people are increased sellers (by at least 10%) based on revenue in the last year compared to the year before?” actually require a complex query in order to retrieve the required data. Comparators provide an accessible language in which to express the values that the query should return. In the above example, the comparator would be “increased” and the subject would be “sales people.” Additional parameters are also specified: the behavior “selling”, the measure “revenue”, the date ranges “last year” and the “year before” and a specific value for the comparator logic “10%”. The comparator uses these parameters to return the value that the user requires. Different comparators are designed to take different mandatory and optional parameter inputs depending on the logic that they are applying in order to generate constraints for the subject.

Specific comparators have been implemented (all, lapsed, new, bottom, bottom percent, top, top percent, above average, average, below average, decreased, decreased or lapsed, increased, new or increased, unchanged), but the invention also discloses the general approach represented by these implemented comparators that is highly extensible, enabling the addition of other comparators within the same framework. Although SQL is used in the examples, this system can be used to generate database queries for other database languages.

Comparators are important because they provide a high level approach to defining subjects based on common patterns of filtering business information. The novice end user can easily select from the predefined comparators and provide value modifications in order to ask precise questions that represent complex relationships within the data. Even when the novice end user is only working with a small set of predefined subjects, the range of questions that can be asked by applying comparators is extensive. Comparators provide a method for asking questions that might otherwise require more advanced mathematical consideration by the novice end user. Using a comparator, the business user can understand what calculation is being performed without needing to understand the details of how it is being performed. The GUI implementation also enables novice end users to optionally see the specific database query (such as SQL) that was generated to understand precisely how the calculation is being performed.

### BRIEF DESCRIPTION OF THE FIGURES

The invention is more fully appreciated in connection with the following detailed description taken in conjunction with the accompanying drawings, in which:

FIG. 1 illustrates general processing associated with an embodiment of the invention.

FIG. 2 illustrates an architectural framework and how a comparator of the invention fits within the architectural framework.

FIG. 3 illustrates comparator processing to produce a database query in accordance with an embodiment of the invention.

FIG. 4 illustrates an exemplary GUI implementation to facilitate the use of comparators in accordance with an embodiment of the invention.

FIG. 5 illustrates a specific comparator-based question within a GUI constructed in accordance with an embodiment of the invention.

FIG. 6 illustrates an answer to a specific question presented within a GUI configured in accordance with an embodiment of the invention.

Like reference numerals refer to corresponding parts throughout the several views of the drawings.

### DETAILED DESCRIPTION OF THE INVENTION

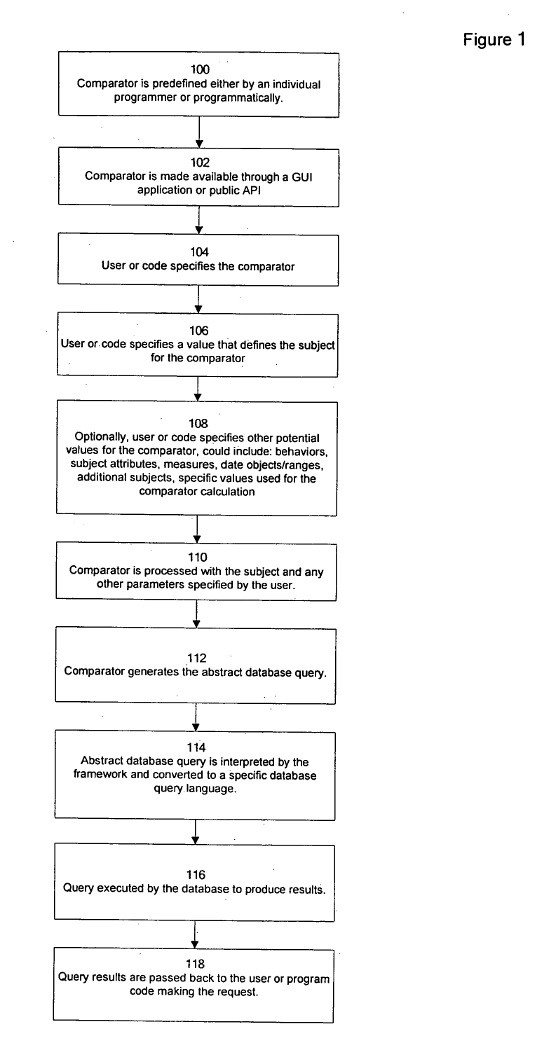

FIG. 1 illustrates processing performed in accordance with an embodiment of the invention. This processing is implemented using executable instructions stored in a computer readable medium. Accordingly, the process of FIG. 1 is a computer-implemented method.

The process starts with a comparator being defined 100. This definition process may be implemented programmatically (e.g., automatically through a code constructor) or by an individual programmer.

After the comparator has been defined, it is provided to a user either through a Graphical User Interface (GUI) or through an Application Program Interface (API) 102. In either case, a comparator is specified 104. The subject corresponding to the comparator is then specified 106. For example, indicating a database column can specify the subject associated with the comparator. Alternately, the subject can be defined based on metadata (e.g., information characterizing database parameters). Optionally, additional values for the comparator are specified 108.

The values that are accepted depend on the logic of the individual comparator, for example, a comparator that calculates whether a subject is in the top percentage of all buyers in a specific region, requires values for the specific “top percentage value number to be returned” (e.g., 20%), “buying” behavior, and a subject attribute—region (e.g. USA). A complex comparator with many optional parameters is generally defined and then the user optionally constructs either more complex or less complex questions based on the number of optional parameters that the user specifies. For example, in the case above, the subject attribute value for region is optionally omitted to construct a less complex question. The potential types of parameter values for a comparator include: behaviors, subject attributes, measures, date objects/ranges, additional subjects, and specific values used for the comparator calculation.

The values that are specified for the comparator are applied when the comparator is processed 110. The comparator facilitates the construction of an abstract database query 112, which is then passed to and interpreted by the framework. The framework converts the abstract database query into a specific database language query and queries the database 114. The query is sent to and executed by the database 116. The results are returned to the user or program code that made the initial request 118. The operations of FIG. 1 may be implemented using any of the techniques described in the following concurrently filed, commonly owned patent applications, each of which is incorporated by reference herein: Apparatus and Method for Deterministically Constructing a Text Question for Application to a Data Source, Ser. No. ______, filed Apr. 7, 2005; Apparatus and Method for Utilizing Sentence Component Metadata to Create Database Queries, Ser. No. ______, filed Apr. 7, 2005; and Apparatus and Method for Data Modeling Business Logic, Ser. No. ______, filed Apr. 7, 2005.

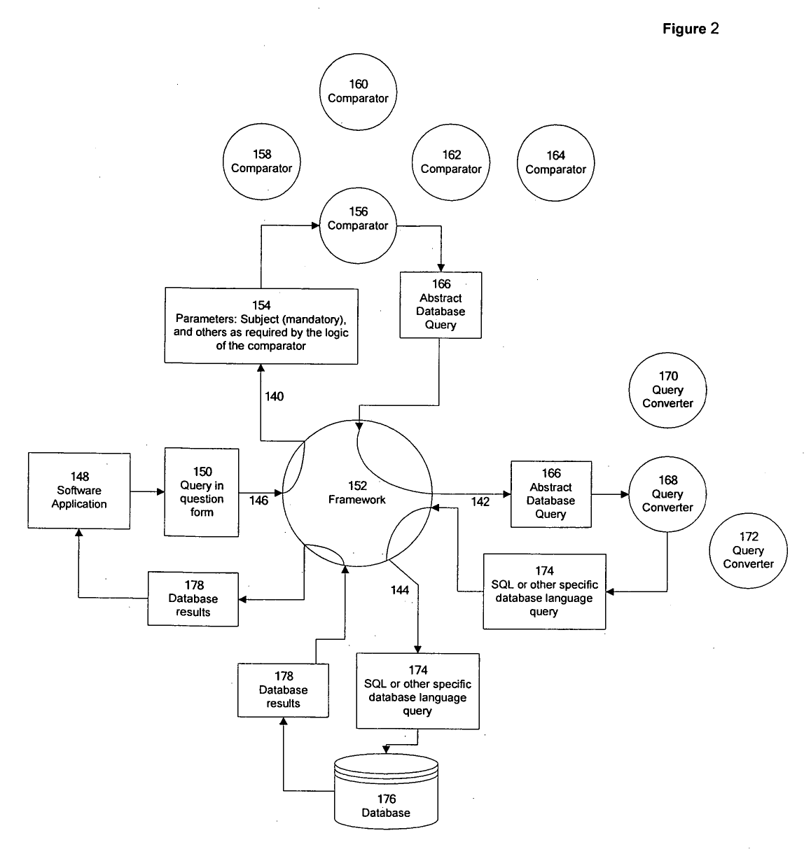

FIG. 2 illustrates how a comparator fits within an architectural framework utilized in accordance with an embodiment of the invention. At the center of the diagram is the framework 152. The software application 148 sends a query in question form 150 to the framework 152. This question could be specified programmatically or by a user working with a GUI application. The framework 152 interprets the question and passes the appropriate parameters (subject and other values accepted by the specific comparator) to a comparator 156. There are a number of available comparators (e.g., 156, 158, 160, 162, and 164) and the framework selects the one comparator 156 that matches the structure of the query in question form 150. The comparator evaluates the parameters based the comparator's predefined logic to produce an abstract database query 166 that the comparator passes back to the framework 152. The framework 152 passes this abstract database query 166 to the query converter 168. Based on the initial query in question form and its output requirements, the framework 152 selects the query converter (e.g., 168, 170, or 172) that will produce the correct specific database language query. The framework 152 passes this specific database language query 174 to the appropriate database 176. From the database 176, the database results 178 are returned and passed to the framework 152. The framework then passes the database results 178 back to the software application 148. The software application 148 can now display the results and/or initiate a new query.

There are four interaction processes 140, 142, 144, 146 associated with the framework 152. These loops involve the framework 152 creating output and receiving input from other components. The process begins with the initial/final loop that inputs the original question and outputs the final database results 146. When the framework interprets the initial question, the correct comparator 156 is selected. The parameters 154 are passed to the comparator 156. The comparator 156 passes back the abstract database query 166. Process 142 takes an abstract database query 166 and passes it to the appropriate query converter to generate a specific database query 174. Process 142 and 140 are similar to process 140, because in both cases the framework 152 selects which object (comparator or query converter) to call based on the information in the question. This modular approach of selecting a discrete comparator or query converter supports the addition of new comparators and new query converters.

In process 144, the framework 152 passes the query 174 to the database 176 to obtain results 178. The framework 152 passes the database results 178 back to the software application 148. The operations of FIG. 2 may be implemented using executable instructions operating on one or more networked machines.

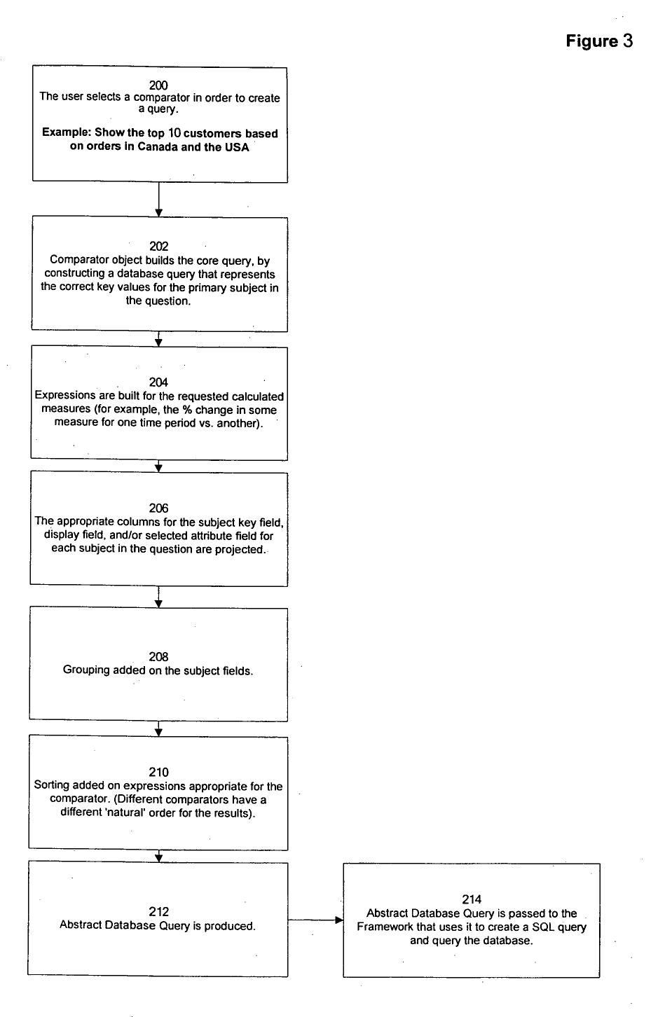

FIG. 3 illustrates how a comparator processes information to produce a database query. In the explanation of this figure, illustrative examples of the components of the query being constructed at a given point are provided. For the sake of readability, this query content is presented in SQL syntax although as is indicated in FIGS. 1 through 3, the syntax of the query would not be constructed as SQL at this point in the process.

The process begins when the user (or program code operating programmatically) selects a comparator in order to create a query 200. At a minimum, the user specifies a subject, but the user may also specify additional values in order to shape more specific questions. To demonstrate the process, suppose that the following sample question is constructed: “Show the top 10 customers based on orders in Canada and the USA”.

The comparator object builds the core query by constructing a database query that represents the correct key values for the primary subject in the question 202. Building this query, the comparator takes into account: the parameters specific to the comparator, the time range restrictions, optional behavior filters, and optional subject filters for all of the subjects in the question.

In this example, a text question is created in which the word “customers” is the subject of the sentence. Executable instructions associated with the comparator forms groups on the primary subject key:
SELECT Customer.custID
FROM Customer
GROUP BY Customer.custID
   Executable code associated with the comparator then adds specific logic:
SELECT TOP 10 Customer.custID
FROM Customer INNER JOIN Orders ON Customer.custID=Orders.orderID
GROUP BY Customer.custID

In this case, the executable code associated with the comparator adds a top statement to specify the range of values to be returned. Depending on the logic of the comparator, a comparator (such as “above average”) may filter the subject based on nested queries rather than a simple statement such as top 10 in the initial query. The additional comparator specific logic also includes the join from “customer” to “orders” to limit the returned customers to those who placed orders. A field from the “orders” table is used as the measure to interpret which customers are in the top 10. To answer other types of questions, additional comparator range restrictions might need to be expressed.

After constructing the basic query that contains the subject key selection and the logic specific to the comparator itself, the executable code associated with the comparator applies behavior and subject filters. In this example, a filter for “customer country” is added to limit the results returned to the countries specified in the initial question (Canada and USA).
SELECT TOP 10 Customer.custID
FROM Customer INNER JOIN Orders ON Customer.custID=Orders.orderID
WHERE Customer.country in (‘Canada’, ‘USA’)
GROUP BY Customer.custID
   These filters could be more complex than shown by this example and might require additional calculations in order to determine the filter criteria.

After this process 202 is completed, expressions are built for the requested calculated measures 204 (for example, the % change in some measure one time period versus another). In the case of this question, “Show my top 10 customers based on orders in Canada and the USA”, the user can specify the information that they want in the returned results in addition to the names of the customers (the subject). For example, it would be logical that the user would want to see the total orders for each customer. In this case, at the point in the process where expressions are built for calculated measures 204, the following code is added to the query in order to secure information about the total orders:
SELECT TOP 10 Customer.custID, SUM(Orders.amount)
FROM Customer INNER JOIN Orders ON Customer.custID=Orders.orderID
WHERE Customer.country in (‘Canada’, ‘USA’)
GROUP BY Customer.custID

After the expressions are built for any requested calculated measures, the appropriate columns for the subject key field, display field, and/or selected attribute field for each subject in the question are added to the set of result columns 206. In the case of the top 10 customers question, two fields are projected by the comparator: the customer name, which is a label used to represent the customer, and the customer title, which is an attribute used to provide additional information about the customer. Preferences around the label/attributes to display can be included in the question or projected based on predefined logic. In this case, the query is modified to return and display the customer name and title rather than the customer ID:
SELECT TOP 10 Customer.name, Customer.title, SUM(Orders.amount)
   FROM Customer INNER JOIN Orders ON Customer.custID=Orders.orderID
   WHERE Customer.country in (‘Canada’, ‘USA’)
   GROUP BY Customer.custID

After the appropriate columns are specified 206, the executable code associated with the comparator adds grouping based on the subject fields 208. In this case, grouping is by customer name, and then customer title:
SELECT TOP 10 Customer.name, Customer.title, SUM(Orders.amount)
FROM Customer INNER JOIN Orders ON Customer.custID=Orders.orderID
WHERE Customer.country in (‘Canada’, ‘USA’)
GROUP BY Customer.custID, Customer.name, Customer.title

After the grouping based on subject fields, the comparator adds specific ordering that is based on the logic contained within the comparator 210. Different comparators have a different ‘natural’ order for the results they produce. The natural order is based on the logic that the comparators are applying to select which subjects to return. Some comparators require that records be ordered in a certain way in order to select the correct elements (such as top/bottom n). For instance, in the case of Top N customers based on order amounts, the order is based on the total order amount since that is the measure by which subjects are selected.
SELECT TOP 10 Customer.name, Customer.title, SUM(Orders.amount)
FROM Customer INNER JOIN Orders ON Customer.custID=Orders.orderID
WHERE Customer.country in (‘Canada’, ‘USA’)
GROUP BY Customer.custID, Customer.name, Customer.title
ORDER BY SUM(Orders.amount) DESC, Customer.name ASC

Steps 202-210 describe the process that is used to produce the abstract database query 212. As stated previously, this abstract database query is not in the SQL syntax that is used in the disclosure for demonstration purposes, rather the abstract query that is produced contains a more generic query structure that can then be translated into a specific database query language. The abstract database query that is produced 212 is passed to the framework that passes it to a query converter that then constructs a query in a specific database language (such as SQL) in order to query the database 214.

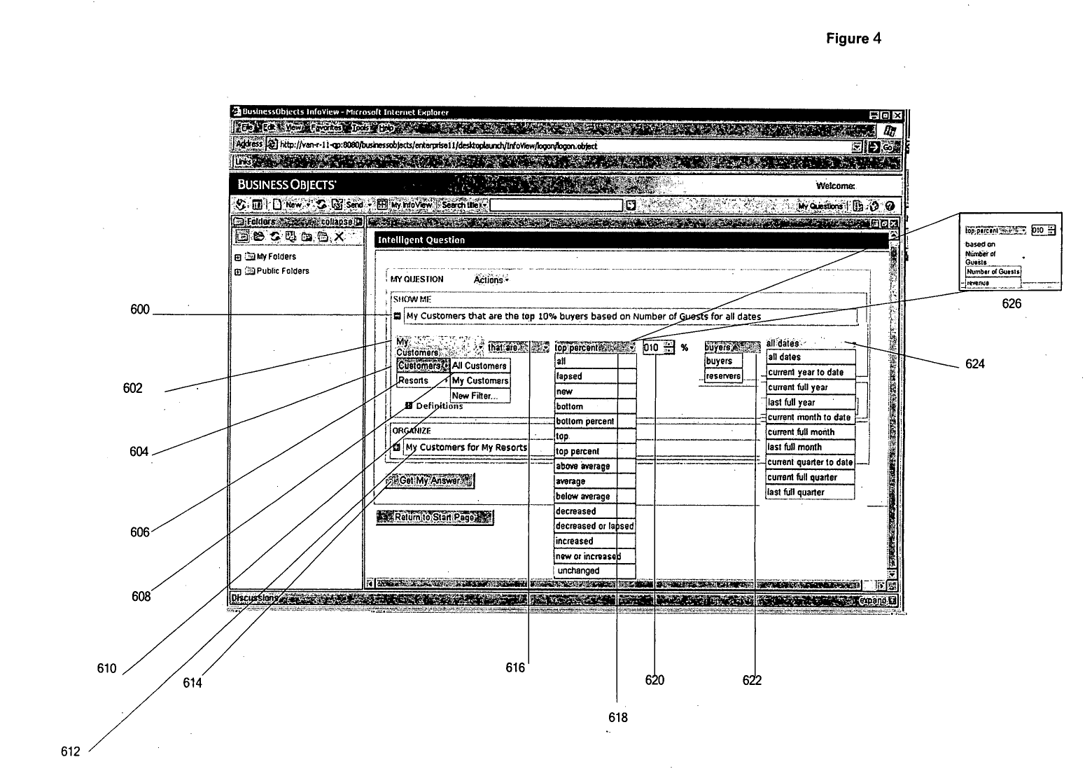

FIG. 4 illustrates an implementation of a GUI interface used for specifying comparators within text questions. Comparators, and the general architecture illustrated in FIG. 2, can be accessed by different GUI applications that represent the logic of the question in different ways. The illustrative GUI of FIG. 4 shows a selected question 600. The GUI provides a user with fields to select values for comparators 618 and subjects 602.

In addition to selecting the comparator 618 and subject 602 for the question 600, the user can specify new subject filters 608 and associate measures 626 with the comparator. If the comparator takes a user specified value, such as top x %, the user can specify that value 620. Other values that can be specified to the comparator using this GUI include positive or negative selection “that are/that are not” 616, behavior associations 622, and dates and date ranges 624 including relative date ranges. The user can also use the organize section 612 to specify the values included in the results (such as subject attributes for both primary and secondary subjects, calculated measures, and additional filters to be applied to the data that is returned).

As illustrated, the user can provide a range of parameter values to the comparator using this interface. Then by clicking “Get my answer” 614 the user starts the process characterized in FIG. 3 that leads to evaluation of the comparator with the specified parameter values and the construction of a database query, and ultimately displaying the requested results to the user.

In the specific implementation that is being discussed, the subjects are predefined based on metadata which provides certain advantages, but it would also be equally possible for a comparator to take a subject that was defined based on table columns without intermediary metadata. In the same way, the behaviors, measures, date objects and ranges, that are based on predefined metadata, in this specific implementation, could be defined based on fact table columns without intermediary metadata.

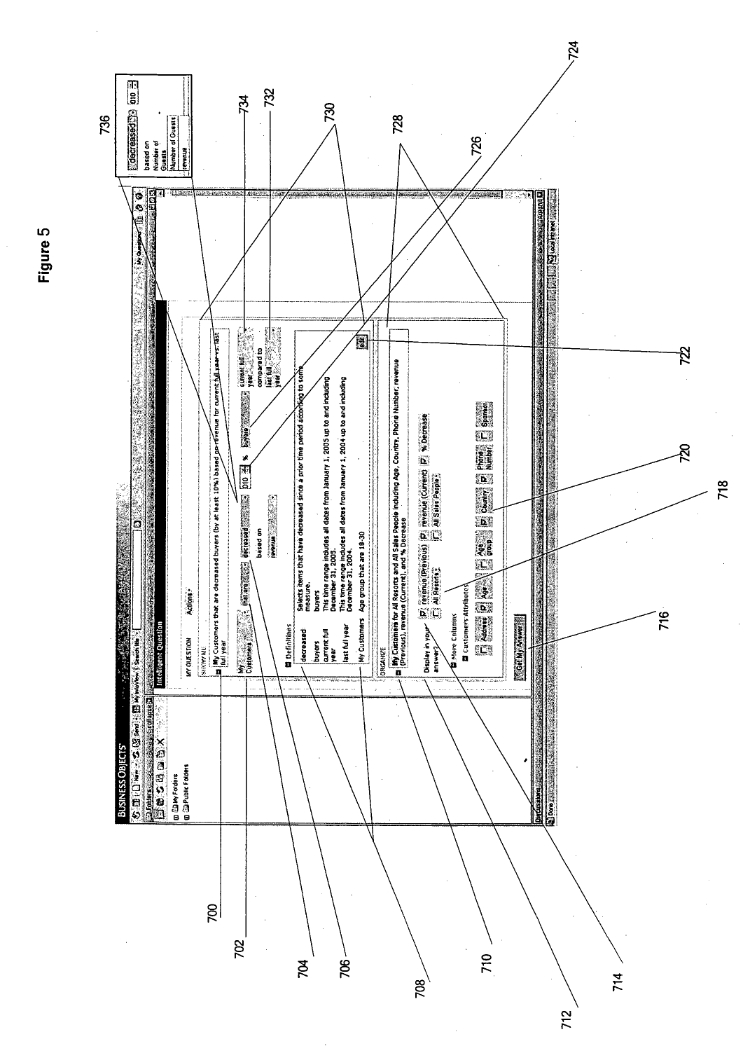

FIG. 5 illustrates a specific question defined within the GUI implementation. In this example, a sales representative user responsible for marketing vacation resorts to younger consumers wants to know which customers have decreased their purchases in the last year so that he can follow up with them individually. The GUI has a section 730 for defining the question. The GUI also has a section 728 for organizing the output associated with the question.

In the question section 730 the question that is asked is summarized 700 as “My customers that are decreased buyers (by at least 10%) based on revenue for the current full year vs. the last full year”. This question concerns the subject “my customers” 702 that has been selected as a filter using the GUI, rather than all customers. As can be seen in the “Definition” section 708 “my customers” is defined as customers in the age group 18-30. The user has selected “decreased” 706 as the comparator that will be used to select which values for the subject to return. As shown in 736, measures for the comparator can be selected (“revenue” and “number of guests” are the options) and the value associated with the comparator 724 can be selected. Two time periods 732 and 734 can be selected to provide the comparative time ranges. The behavior option 726, in this case “buying” and the “are/are not” 704 option are also selected. As shown in FIG. 2, when this question is passed to the framework, the framework calls the comparator for decreased and passes the comparator the value for the subject “my customers” 702. In addition to the value for the subject, parameters for: “are/are not” 704, the measure 736, the behavior 726, the time periods 732 and 734 and other comparator specific arguments, in this case “10%”, 724 are passed from the framework to the comparator.

In addition to the question, the user can select which calculated values and attributes to display in the results that are returned using the lower section of the GUI 728. In this case the aggregated calculations 714 include the “revenue (Previous)” and “revenue (Current)” and the “% Decrease”. The user can also select whether to show additional subjects 718 (resorts, sales people) in the returned results. If additional subjects are selected, the option to return attributes for those subjects will also be available. For the subjects, attributes to be displayed in the returned results 720 are selected, i.e., “Age”, “Country”, and “Phone Number”. When the user clicks “Get My Answer” button 716, the question is sent to the framework and is processed in the manner shown in FIG. 2.

As shown in FIG. 2, the framework calls the comparator that matches the question and passes the comparator the appropriate parameters. The comparator passes an abstract database query back to the framework, which the framework then passes to the query converter. In the case of the question in FIG. 5, the SQL representation of the original question that the query converter passes back to the framework may be:

SELECT

Q.Customers AS Customers,
Q.Age AS Age,
Q.Country AS Country,
Q.[Phone Number] AS [Phone Number],
Q.COL_VALUE5 AS [revenue (last full year)],
Q1.COL_VALUE2 AS [revenue (current full year)],

(1.0 - IIF(ISNULL(Q1.COL_VALUE2), 0.0, Q1.COL_VALUE2)
/ IIF(Q.COL_VALUE5 = 0.0, NULL, Q.COL_VALUE5)) * 100.0 AS [% decrease]
FROM

(SELECT
Customer.last_name AS Customers,
Customer.age AS Age,
Country.country AS Country,
Customer.phone_number AS [Phone Number],
SUM(Invoice_Line.days * Invoice_Line.nb_guests * Service.price) AS COL_{—VALUE5}
FROM

(((Country INNER JOIN ((City INNER JOIN Customer ON
City.city_id = Customer.city_id) INNER JOIN Region ON
City.region_id = Region.region_id) ON Country.country_id = Region.
country_id)
INNER JOIN Sales ON Customer.cust_id = Sales.cust_id
INNER JOIN Invoice_Line ON Sales.inv_id = Invoice_Line.inv_id)

INNER JOIN Service ON Invoice_Line.service_id = Service.service_id

WHERE
Sales.invoice_date >= {ts ‘2004-01-01 00:00:00.0’}
AND Sales.invoice_date < {ts ‘2005-01-01 00:00:00.0’}

AND Age_group.age_range IN (‘18-30’)

GROUP BY

Customer.last_name,
Customer.age,
Country.country,
Customer.phone_number

)AS Q

INNER JOIN (
SELECT

Customer.last_name AS COL_VALUE1,
SUM(Invoice_Line.days * Invoice_Line.nb_guests * Service.price) AS COL_{—VALUE2}

FROM

((Customer

INNER JOIN Sales

ON Customer.cust_id = Sales.cust_id)

INNER JOIN Invoice_Line

ON Sales.inv id = Invoice_Line.inv_id)

INNER JOIN Service

ON Invoice_Line.service_id = Service.service_id

WHERE
Sales.invoice_date >= {ts ‘2005-01-01 00:00:00.0’}
AND Sales.invoice_date < {ts ‘2006-01-01 00:00:00.0’}
AND Age_group.age_range IN (‘18-30’)

GROUP BY

Customer.last_name

) AS Q1 ON Q.Customers = Q1.COL_VALUE1

WHERE

Q.COL_VALUE5 IS NOT NULL

AND (Q1.COL_VALUE2 IS NULL

OR Q1.COL_VALUE2 <= Q.COL_VALUE5 * 0.9)

ORDER BY (1.0 - IIF(ISNULL(Q1.COL_VALUE2), 0.0, Q1.COL_VALUE2)/
IIF(Q.COL_VALUE5 = 0.0, NULL, Q.COL_VALUE5)) * 100.0 DESC,

Q.COL_VALUE5 DESC,
Q.Customers ASC,
Q.Age ASC,
Q.Country ASC,
Q.[Phone Number] ASC

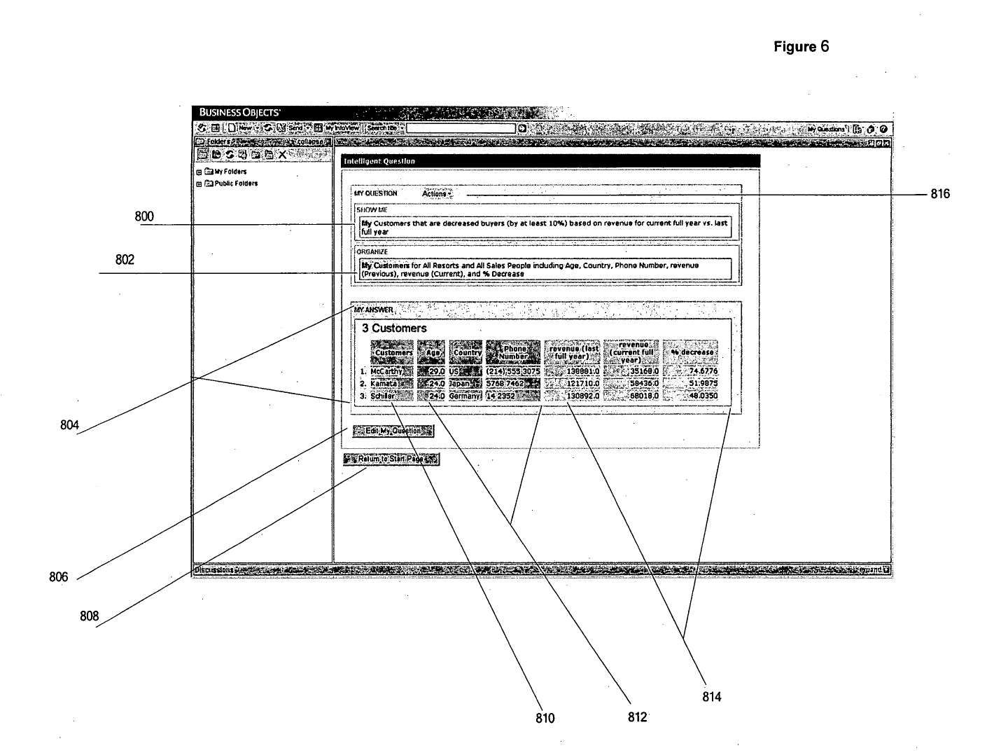

The framework passes this query to the database to retrieve the specific database results. These results are passed to the framework, which then provides the database; results to the initial requesting software program. The software program then displays the results that have been returned, as illustrated in FIG. 6.

FIG. 6 illustrates the answer to the question specified in FIG. 5. Two summary fields show the question that was asked 800 and the attributes and information requested for the question results 802. The answer is displayed 804 with the specific database results that match the question criteria. The first column 810 identifies the subject, the next three columns 812 show the subject attributes that were selected (age, country, phone number) and the next three columns 814 show the calculated values that were selected (previous revenue, current revenue, and percent decrease). These are the values that were selected in section 728 of FIG. 5. In addition to the returned results, the GUI provides an action menu 816 with options for saving, exporting, or viewing the SQL of the question. The user can also select 806, “Edit My Question” to alter the question and initiate the process described in FIG. 2 by passing a new question to the framework.

Those skilled in the art will appreciate that any number of comparators may be utilized in accordance with embodiments of the invention. By way of example, the following comparators may be used with embodiments of the invention:

| Comparator | Description |
|---|---|
| All | This comparator includes all items in |
| | the specified time range. |
| New | This comparator includes items that are |
| | in the current time range, but not in the |
| | specified earlier time range. |
| Lapsed | This comparator includes items that are |
| | in the earlier time range, but not in the |
| | current time range. |
| Remaining | This comparator includes items that are |
| | in the current time range and in the |
| | specified earlier time range. |
| Top N | The Top N comparator selects the N |
| | items that have the highest aggregated |
| | value for the specified measure. |
| Top N Percent | The Top N Percent comparator selects |
| | the N percent of items that have the |
| | highest aggregated value for the |
| | specified measure. |
| Bottom N | The Bottom N comparator selects the |
| | N items that have the lowest |
| | aggregated value for the specified |
| | measure. |
| Bottom N Percent | The Bottom N Percent comparator |
| | selects the N percent of items that have |
| | the lowest aggregated value for the |
| | specified measure. |
| Greater Than | This comparator selects the items |
| | where the aggregated measure values |
| | exceed the specified value. |
| Less Than | This comparator selects the items |
| | where the aggregated measure values |
| | are below the specified value. |
| Between | This comparator selects the items |
| | where the aggregated measure values |
| | are within the range specified by the |
| | lower and upper bound values. |
| Above Average | This comparator selects the items that |
| | are at least the specified amount above |
| | the average value based on the |
| | aggregated values for the specified |
| | measure. |
| Below Average | This comparator selects the items that |
| | are at least the specified amount below |
| | the average value based on the |
| | aggregated values for the specified |
| | measure. |
| Average | This comparator selects the items that |
| | are within specified amount of the |
| | average value based on the aggregated |
| | values for the specified measure. |
| Increased | This comparator selects the items that |
| | have increased by at least the specified |
| | amount from the earlier time range |
| | based on the aggregated values for the |
| | specified measure. |
| Decreased | This comparator selects the items that |
| | have decreased by at least the specified |
| | amount from the earlier time range |
| | based on the aggregated values for the |
| | specified measure. |
| Unchanged | This comparator selects the items that |
| | have changed by less than the specified |
| | amount from the earlier time range |
| | based on the aggregated values for the |
| | specified measure. |

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium including executable instructions to construct a database query based on a comparator, including executable instructions to:
accept a comparator forming a part of a text question;
receive a value that defines a subject within said text question; and
build a structured database query based upon said comparator and said subject of said text question.

2. The computer readable medium of claim 1 wherein said executable instructions to accept a comparator include executable instructions to accept a comparator value selected from: lapsed, new, bottom, bottom percent, top, top percent, above average, average, below average, decreased, increased, and unchanged.

3. The computer readable medium of claim 1 wherein said executable instructions to accept a comparator include executable instructions to accept a comparator parameter selected from: date objects, date ranges, measures, behaviors, and subject attributes.

4. The computer readable medium of claim 1 further comprising executable instructions to combine the logic of two comparators.

5. The computer readable medium of claim 1 further comprising executable instructions to utilize said comparator to sort data in accordance with an expression.

6. The computer readable medium of claim 1 wherein said executable instructions to build a structured database query include executable instructions to build a structured query language (SQL) database query.

7. A computer readable medium including executable instructions to construct a database query based on a comparator, including executable instructions to:
process a text question to identify a comparative expression within said text question;
associate said comparative expression with the subject of said text question; and
select a comparator based upon said subject and said comparative expression.

8. The computer readable medium of claim 7 further comprising executable instructions to form an abstract database query based upon said comparator.

9. The computer readable medium of claim 8 further comprising executable instructions to select a query converter based upon said abstract database query.

10. The computer readable medium of claim 9 wherein said query converter includes executable instructions to generate a database language query.

11. The computer readable medium of claim 10 further comprising executable instructions to apply said database language query to a database to produce database results.

12. The computer readable medium of claim 11 further comprising executable instructions to deliver said database results to an application program that generated said text question.
